(19) United States
(12) Patent Application Publication
(10) Pub. No.: US 2024/0301722 A1
(43) Pub. Date: Sep. 12, 2024

(54) IMPROVED DOOR LOCK SYSTEM

(71) Applicant: Graeme McGrath, Queensland (AU)

(72) Inventor: Graeme McGrath, Queensland (AU)

(21) Appl. No.: 18/551,448

(22) PCT Filed: Mar. 15, 2022
(86) PCT No.: PCT/AU2022/050221

§ 371 Date: Sep. 20, 2023

(30) Foreign Application Priority Data
Mar. 22, 2021 (AU) 2021900828
Jun. 7, 2021 (AU) 2021901690

(51) Int. Cl. E05B 63/08; E05B 13/00; E05B 55/00; E05B 65/02; E05C 9/04

(52) U.S. Cl. CPC E05B 63/08; E05B 13/005; E05C 9/047; E05B 55/00; E05B 65/02

(57) ABSTRACT

A door lock system, an external digital access control assembly and an inner door handle assembly for use on a pivotally mounted door is provided. The door lock system includes: an external digital access control assembly, including a digital access control component and a handle; and a mechanical mortice, mechanically coupled to the external digital access control assembly. The digital access control component is configured to selectively provide access control by mechanically coupling and decoupling the handle to the mechanical mortice.

### TECHNICAL FIELD

The present invention relates to improved door locks. In particular, although not exclusively, the present invention relates to an improved digital door lock for a residential security screen door.

### BACKGROUND ART

Locks and keys have long been used to restrict access to residential buildings. In particular, locks are placed on each external door of the building, which restricts access to the building through the door unless the corresponding key is used to unlock the lock.

More recently, digital locks have increased in popularity. In some such systems, a keypad is used to enable a user to access the building using a pin code rather than a physical key. Alternatively or additionally, an access control tag or device is used to provide access to the building.

In warm climates, security screen doors (also referred to as storm doors) are popular, as they provide access control and provide an insect barrier while allowing airflow (ventilation). Modern security screen doors often comprise an aluminium frame with a mesh screen therein, and are typically positioned immediately adjacent to an outside of an external door. In such case, the screen door generally opens outwardly and the external door opens inwardly, enabling the external door to be open while the screen door is shut.

A problem with digital locks in such scenario is that they are not well suited to these screen doors. Screen doors are generally much thinner than external doors (19 mm vs 40 mm), and digital mortices for external doors can thus not be used on screen doors. Furthermore, as screen doors are generally placed directly against the external door (when both are closed), the large door handle assemblies typically used for digital locks are not suitable.

As a result, a digital lock is typically only used on the external door. A user must therefore use a key to unlock the screen door if it is locked, countering several of the benefits of digital locks. In particular, if a user is required to carry a traditional key, the motivation to, and benefit from, installing a digital lock is reduced.

As such, there is clearly a need for improved door lock systems.

It will be clearly understood that, if a prior art publication is referred to herein, this reference does not constitute an admission that the publication forms part of the common general knowledge in the art in Australia or in any other country.

### SUMMARY OF INVENTION

The present invention is directed to door lock systems, which may at least partially overcome at least one of the abovementioned disadvantages or provide the consumer with a useful or commercial choice.

With the foregoing in view, the present invention in one form, resides broadly in a door lock system for use on a pivotally mounted door, the door lock system including:
an external digital access control assembly, including a digital access control component and a handle; and
a mechanical mortice, mechanically coupled to the external digital access control assembly;
wherein the digital access control component is configured to selectively provide access control by mechanically coupling and decoupling the handle to the mechanical mortice.

Advantageously, the door lock system provides digital access control without requiring an electronic mortice. This enables the mechanical mortice to be smaller and thinner than a corresponding electronic mortice. As the system provides access control by mechanically coupling and decoupling the handle to the mechanical mortice, the system does not require an electrical actuator for actuating the mechanical mortice. This enables the lock system to be smaller than a corresponding system using an electrical actuator.

Preferably, the door lock system is configured to be installed on a residential door.

Preferably, the door lock system is configured to be installed on a screen door. The abovementioned features enable a simple and compact mortice to be used, and does not require any electrical actuators, which are typically placed on an inside of the door. As such, the system is particularly suited for use on screen doors which are located immediately adjacent to an external door (and thus do not have significant space between the screen door and the external door).

Preferably, the external digital access control assembly is located entirely on an outside of the door. Such configuration avoids the need for wires extending through the door. Furthermore, any internal door furniture may be entirely mechanical.

Preferably, the external digital access control assembly includes one or more batteries, for powering the external digital access control assembly. The batteries may be housed in a housing of the external digital access control assembly.

Preferably, the door lock system does not include any actuator or motor for rotating a spindle or otherwise actuating the mechanical mortice.

Preferably, the door lock system includes a clutch, configured to selectively couple the handle to the mechanical mortice. When engaged, the clutch may transfer rotation of the handle to rotation of a spindle.

The clutch may be configured to temporarily couple the handle to the mechanical mortice upon instruction from the digital access control component.

The clutch may selectively couple the handle to the mechanical mortice using a spindle.

The clutch may couple the handle to the mortice when the handle is turned in one direction, and not when the handle is turned in the other direction.

Preferably, the door lock system includes a keypad. Preferably, the keypad is configured to receive a code, and provide access control dependent on whether the code is a valid code. The code may be configurable by a user.

The keypad may be provided on an outer surface of the external digital access control assembly.

Preferably, the mortice comprises a centre mortice lock, wherein the system includes an upper and lower lock coupled to the centre mortice lock.

Preferably, the centre mortice lock is coupled to the upper and lower locks by one or more actuating bars and/or actuating rods, which are configured to lock/unlock the upper and lower locks through linear movement.

Preferably, the mortice comprises an actuating assembly, coupled to the handle, and a linear actuating member, configured to actuate the upper and lower locks, wherein rotation of the actuating assembly causes linear movement of the linear actuating member. As such, the system may provide three-point locking through movement of the handle (rather than requiring a key).

Preferably, the lock system includes a lock cylinder, configured to provide keyed access control as an alternative to the external digital access control assembly.

The lock cylinder may include a cam, coupled to a barrel thereof, configured to cause translation of a linear actuating member to thereby unlock the door.

Preferably, the lock system includes an internal handle that is selectively coupled to a spindle of the lock by one or more buttons. The button may be located on the handle. The button may be located on an inside of the handle.

The button may be configured to selectively couple the handle to a spindle of the lock by engaging with a keyed portion of the spindle.

In another form, the invention resides broadly in an external digital access control assembly for use on a pivotally mounted door, the external digital access control assembly including:
a digital access control component; and
a handle;
wherein the digital access control component is configured to selectively provide access control by mechanically coupling and decoupling the handle to a mortice.

In another form, the invention resides broadly in an inner door handle assembly for use on a pivotally mounted door, the inner door handle assembly comprising a handle member including a manually activated engagement mechanism, wherein the manually activated engagement mechanism engages with a spindle of the door when the manually activated engagement mechanism is activated, and does not engage with the spindle of the door when the manually activated engagement mechanism is not activated, such that rotation of the handle causes rotation of the spindle when the manually activated engagement mechanism is activated and rotation of the handle is independent of the spindle when the manually activated engagement mechanism is not activated.

Preferably, the manually activated engagement mechanism includes one of a slider and a button.

Preferably, the manually activated engagement mechanism includes a pin, configured to engage with a keyed head of the spindle.

Preferably, the manually activated engagement mechanism is engageable by lateral movement along an axis of the handle.

Preferably, the manually activated engagement mechanism includes a biasing spring to bias the manually activated engagement mechanism to an open (not activated) configuration.

Any of the features described herein can be combined in any combination with any one or more of the other features described herein within the scope of the invention.

The reference to any prior art in this specification is not, and should not be taken as an acknowledgement or any form of suggestion that the prior art forms part of the common general knowledge.

### BRIEF DESCRIPTION OF DRAWINGS

Various embodiments of the invention will be described with reference to the following drawings, in which:

FIG. 1 illustrates a door lock system, according to an embodiment of the present invention.

FIG. 2 illustrates an internal portion of the door lock system of FIG. 1.

FIG. 3 illustrates a cut-away view of a centre mortice lock of the door lock system of FIG. 1.

FIG. 4 illustrates an outside view of a digital handle assembly of the door lock system of FIG. 1.

FIG. 5 illustrates a front view of the digital handle assembly of the door lock system of FIG. 1.

FIG. 6 illustrates an inside view of the digital handle assembly of the door lock system of FIG. 1.

FIG. 7 illustrates a rear view of the digital handle assembly of the door lock system of FIG. 1.

FIG. 8 illustrates a front view of an inner handle assembly of the door lock system of FIG. 1.

FIG. 9 illustrates an outside view of an inner handle assembly of the door lock system of FIG. 1.

FIG. 10 illustrates an inside view of an inner handle assembly of the door lock system of FIG. 1.

FIG. 11 illustrates a lower perspective view of the inner handle assembly of the door lock system of FIG. 1.

FIG. 12 illustrates a cross-sectional view of the inner handle assembly of the door lock system of FIG. 1 with a button thereof in an extended (default) position.

FIG. 13 illustrates a cross-sectional view of the inner handle assembly of the door lock system of FIG. 1 with the button in the pressed position.

FIG. 14 illustrates a lower front perspective view of an inner handle assembly of the door lock system of FIG. 1.

FIG. 15 illustrates a cross-sectional view of the inner handle assembly of FIG. 14 with a sliding tab member thereof in an extended (default) position.

Preferred features, embodiments and variations of the invention may be discerned from the following Detailed Description which provides sufficient information for those skilled in the art to perform the invention. The Detailed Description is not to be regarded as limiting the scope of the preceding Summary of the Invention in any way.

### DESCRIPTION OF EMBODIMENTS

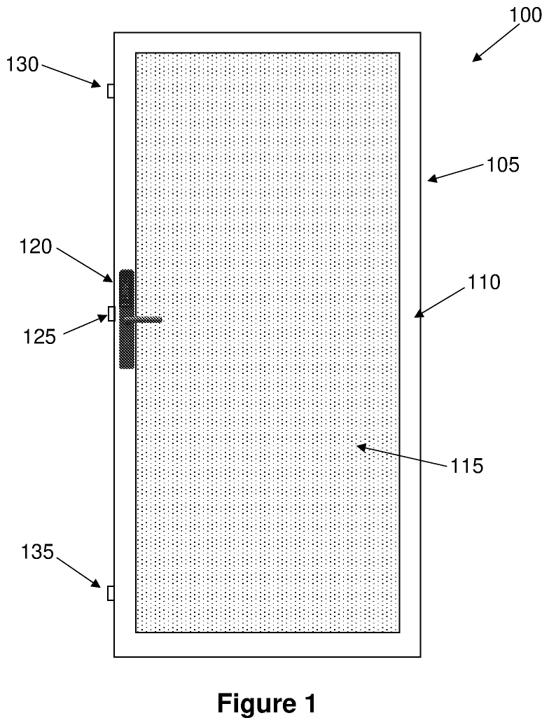

FIG. 1 illustrates a door lock system 100, according to an embodiment of the present invention. The door lock system 100 provides a simple and effective manner of utilising digital lock technology on a security screen door together with 3-point locking, as outlined below.

The door lock system 100 includes an aluminium screen door 105, comprising an aluminium frame 110 and a screen sheet 115 filling the frame. The screen sheet 115 may be formed of mesh, such as woven stainless-steel mesh.

The door lock system 100 includes a digital handle assembly 120, configured to provide access control using a keypad thereof, as outlined in further detail below. The digital handle assembly 120 is coupled to a centre mortice lock 125, and thereby to a top and bottom lock 130, 135, to provide 3-point locking, also as outlined in further detail below.

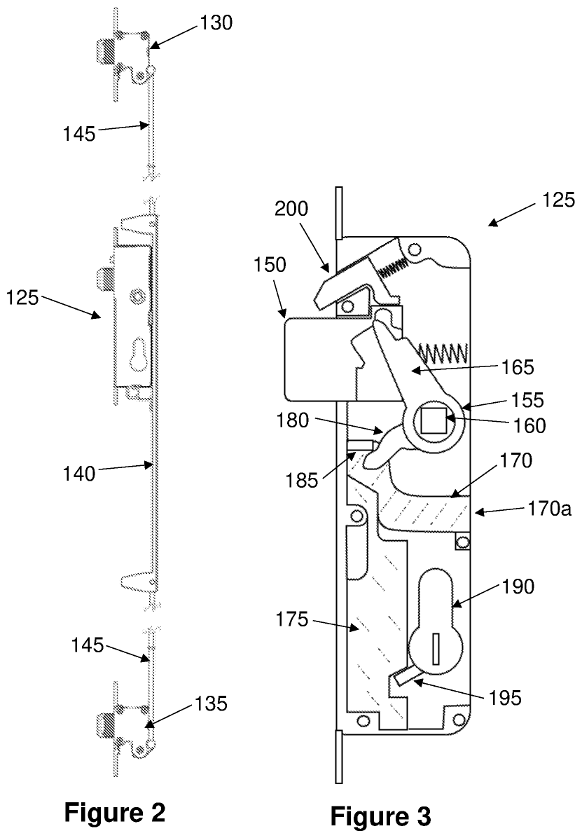

FIG. 2 illustrates an internal portion of the door lock system 100, i.e. the parts which are housed in the screen door 105.

The door lock system 100 comprises a centre mortice lock 125, which is coupled to the top lock 130 and a bottom lock 135 by an actuating bar 140 and rods 145. When the centre mortice lock 125 is locked/unlocked, the actuating bar 140 is translated vertically, thereby locking/unlocking the top lock 130 and the bottom lock 135.

FIG. 3 illustrates a cut-away view of the centre mortice lock 125, showing internals of the centre mortice lock 125 in a locked position.

The centre mortice lock 125 includes a tongue 150 (bolt), which engages with a striker plate associated with the door 105, to prevent the door 105 from opening. While not shown in the same level of detail, the top and bottom locks 130, 135 similarly include tongues, which engage with respective striker plates associated with the door 105.

The centre mortice lock 125 includes an actuator assembly 155, which is coupled to handles of the lock system 100. In particular, the actuator assembly 155 includes a square aperture 160, through which a spindle, coupled to the handles, extends. Rotation of the spindle causes rotation of the actuator assembly 155 around an axis of the spindle.

The actuator assembly 155 includes an upper arm member 165, which extends to and engages with an inside portion of the tongue 150. Rotation of the actuator assembly 155 in the clockwise direction (e.g. by pulling the handle downwardly) causes the upper arm member 165 to retract the tongue 150, not only unlocking the centre mortice lock 125, but ultimately retracting the tongue 150, and fully disengaging the tongue 150 from the striker.

The centre mortice lock 125 further includes first and second linear actuating members 170, 175. The actuator assembly 155 includes a lower arm member 180, which extends to and engages with a tab 185 of the first linear actuating member 170. Rotation of the actuator assembly 155 in the clockwise direction causes the lower arm member 180 to lift the first actuating member 170. An inner end 170a of the first actuating member 170 includes an aperture, which engages with a locating lug of the actuating bar 140. As such, movement of the first actuating member 170 locks/unlocks the top lock 130 and the bottom lock 135.

Such configuration provides an effective means for locking and unlocking the door 105 without requiring use of a lock cylinder. As such, this configuration is particularly suited for used with the digital lock, as it does not require the use of a key to provide three-point locking.

A lock cylinder 190 is provided in a lower portion of the centre mortice lock 125, to enable key-based use, e.g. as a backup. In such case, a cam 195 coupled to the barrel of the cylinder 190 engages with the second linear actuating member 175 such that when the cylinder is unlocked (by rotation of a key), the second linear actuating member 175 is actuated vertically such that it engages with and actuates the first linear actuating member 170, and engages with the lower arm member 180, thereby unlocking the centre mortice lock 125 and the top and bottom locks 130, 135.

The centre mortice lock 125 includes an auxiliary tongue 200, which prevents locking of the lock 125 unless the door 105 is closed. In particular, an upper edge of the tongue 150 engages with the lower portion of the auxiliary tongue 200 when the auxiliary tongue is fully extended. When the door is closed, the auxiliary tongue 200 is pressed inwards, enabling the tongue 150 to move freely.

Both the tongue 150 and auxiliary tongue 200 are urged to their extended positions by respective springs.

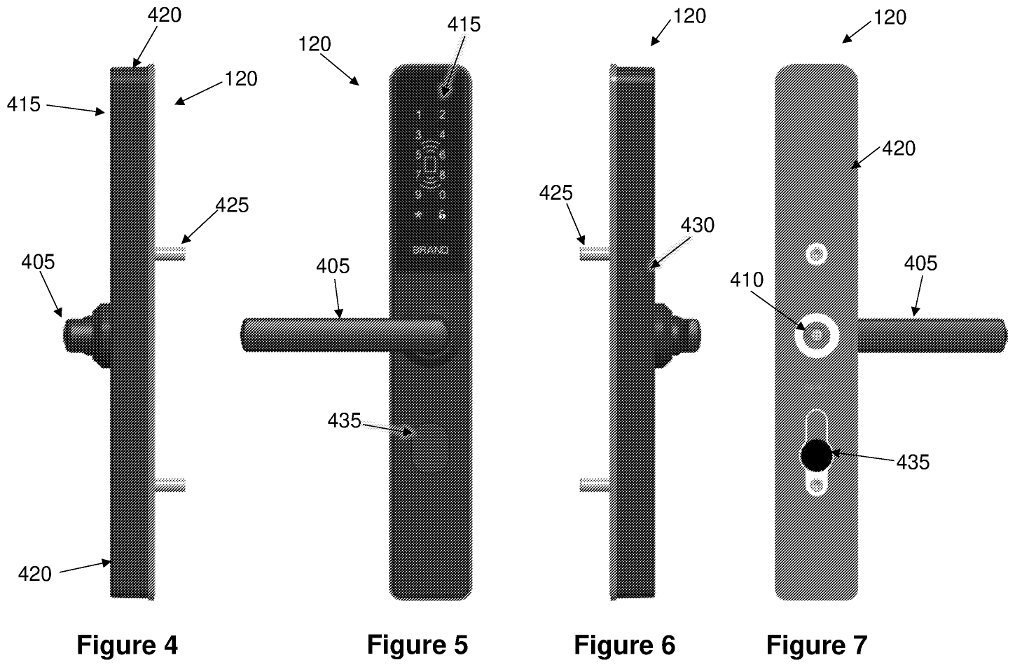

FIG. 4 illustrates an outside view of the digital handle assembly 120. FIG. 5 illustrates a front view, FIG. 6 illustrates an inside view, and FIG. 7 illustrates a rear view of the digital handle assembly 120.

As can be seen from the description above, rotation of the actuator assembly 155 in the centre mortice lock 125 unlocks the door 105.

As such, the digital handle assembly 120 includes a clutch coupled between a handle 405 thereof and a spindle receiver 410, and thereby the actuator assembly 155, to prevent rotation of the spindle, and thereby the actuator assembly 155, unless a valid code is entered on a keypad 415. As such, unless a valid code is entered, the clutch is disengaged, rendering the handle 405 inoperative.

The keypad 415 includes a plurality of keys comprising digits (1-0), an asterisk and a lock button. The keys are not only used for access control, but also to program the digital handle assembly 120.

The digital handle assembly 120 includes a housing 420 (escutcheon), which houses all electronics associated with the door lock system 100, and batteries. As such, no wiring is needed to extend into or through the door. This allows the internal furniture of the lock system 100 to be entirely mechanical and small, which is particularly useful when used in a screen door which is typically located immediately outside of an external door.

Fastening members 425, extend through the door 105, from a substantially planar rear surface of the handle assembly 120, and engage with fasteners on an inside of the door 105.

A speaker 430 is provided on a side of the handle assembly 120, to provide audible feedback to a user.

Finally, a resealable cylinder access point 435 is provided to enable access to a cylinder of the mortice 125, e.g. for emergency use.

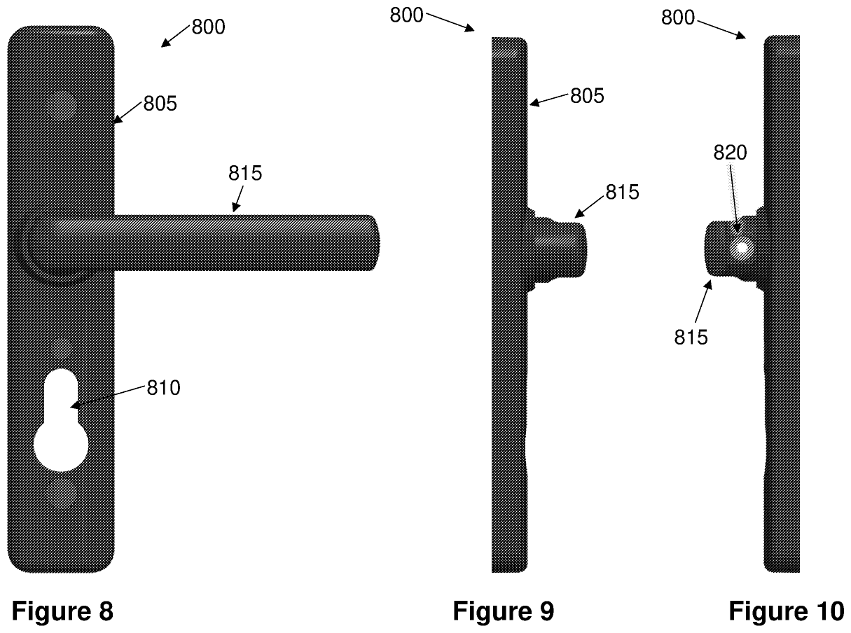

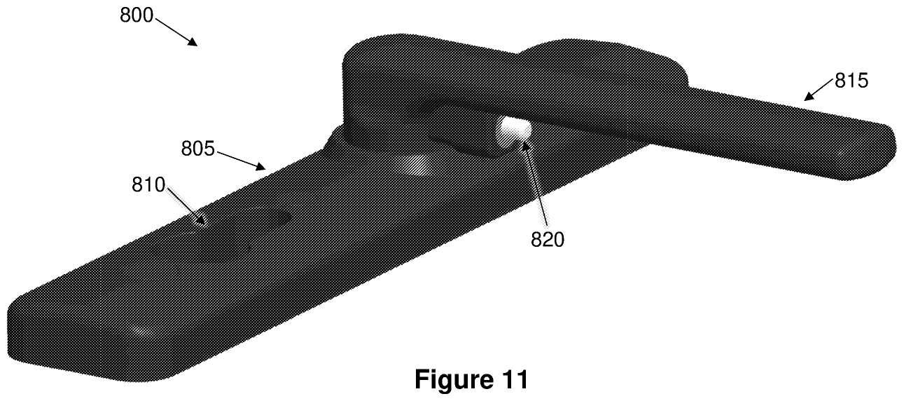

FIG. 8 illustrates a front view of an inner handle assembly 800 of the door lock system 100. FIG. 9 illustrates an outside, FIG. 10 illustrates an inside, and FIG. 11 illustrates a lower perspective view of the inner handle assembly 800.

The handle assembly 800 is similar to that of a traditional internal handle assembly of a screen door, and includes an escutcheon 805 having a cylinder access point 810, and an elongate handle 815 extending outwardly therefrom.

The handle 815 is selectively coupled to a spindle of the lock system 100 by a button 820, that is located on inside of the handle. Such location prevents accidental engagement of the button 820, which making it easy to use with one hand. As an illustrative example, an index finger of the user may press the button 820 while opening the door.

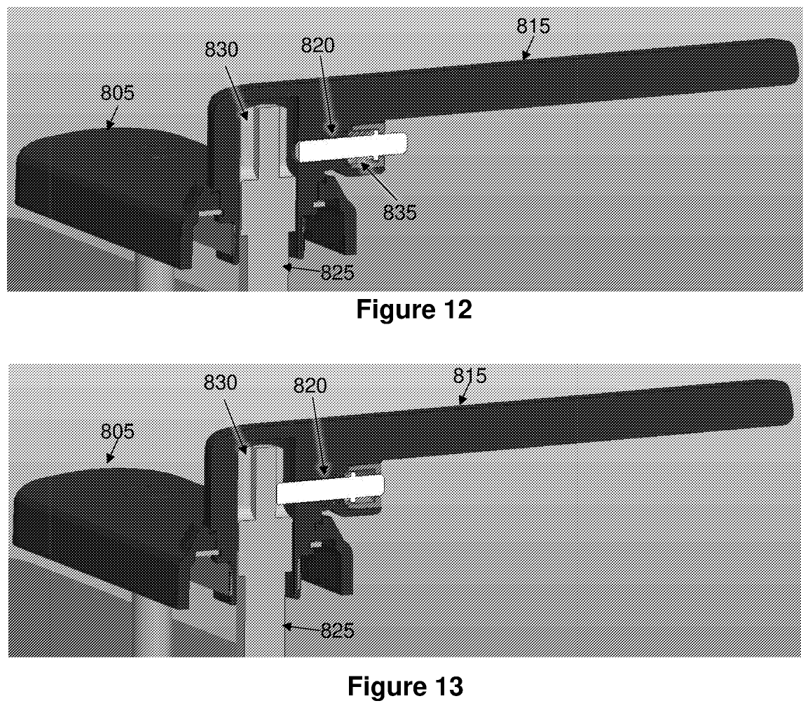

FIG. 12 illustrates a cross-sectional view of the inner handle assembly 800 with the button 820 in an extended (default) position, and FIG. 13 illustrates a cross-sectional view of the inner handle assembly 800 with the button 820 in the pressed position.

A keyed spindle 825 extends through the door and into the handle assembly 800. An end of the keyed spindle 825 comprises a keyed portion 830, which engages with the button 820 when pressed, and does not engage with the button 820 when not pressed.

The button 820 is thus configured to selectively couple the handle 815 to the spindle 825 through such selective engagement. When the button 820 is pressed, an inner end of the button extends into and engages with the keyed portion 830 of the spindle 825 such that rotation of the handle 815 causes rotation of the spindle 825. When the button 820 is not pressed (default), rotation of the handle 815 is independent of the spindle 825.

Finally, the inner handle assembly includes a spring 835 biasing the button 820 to an extended (default) position.

The button 820 thus functions much like a snib, but instead of unlocking the lock through a separate mechanism, utilises rotation of the handle 815. As such, the inner lock handle functions much like the outer handle in that simply rotation of the handle 815 has no function. However, instead of a clutch, the inner handle assembly includes the button 820 which engages with the spindle.

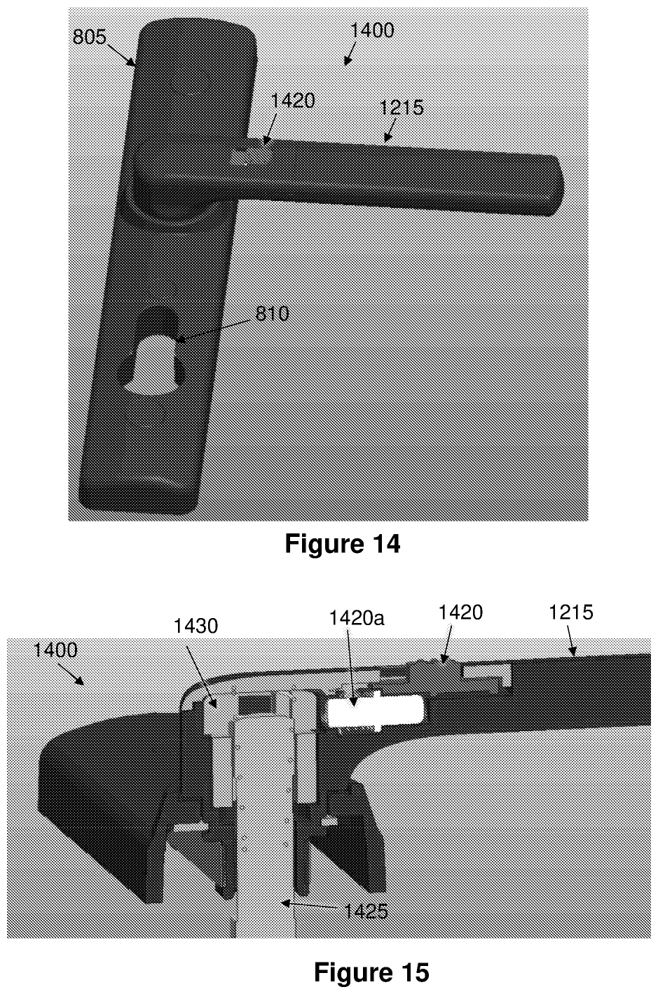

FIG. 14 illustrates a lower front perspective view of an inner handle assembly 1400 of the door lock system 100. The inner handle assembly 1400 is similar to the inner handle assembly 800 of the system 100, and is interchangeable therewith, but includes a sliding tab member 1420 rather than a button 820.

FIG. 15 illustrates a cross-sectional view of the inner handle assembly 1400 with the sliding tab member 1420 in an extended (default) position.

A spindle 1425 with a keyed head 1430 attached thereto extends through the door and into the handle assembly 1400. When the sliding tab member 1420 is slid, it causes a pin 1420a to slide, and engage with the keyed head 1430. The pin 1420a is biased by a spring to an open position, such that the pin engages with the keyed head 1430 when the sliding tab member 1420 is slid, and does not engage with the keyed head 1430 when not slid.

The sliding tab member 1420 is thus configured to selectively couple the handle 1215 to the spindle 1425 through such selective engagement. When the slider 1420 is slid, an inner end of the pin 1420 extends into and engages with the keyed head 1430 such that rotation of the handle 1215 causes rotation of the spindle 1425. When the slider 1420 is not slid (default), rotation of the handle 1215 is independent of the spindle 1425.

In other embodiments, the button 820 may be placed on an outside of the door handle. In such case, a thumb of the user may press the button 820 while opening the door.

The button 820 may comprise a button that is pressed. The button 820 may comprise a button that is slid.

The inner handle assembly is thin, making it suitable for use when the screen door is located immediately adjacent to an external door. It is able to be thin as no electronics, batteries or similar need be located on the inside of the door.

The lock systems described above may be used on screen door installations where digital access control is also provided on an external door associated with the security screen. As such, digital access control may be provided to the building through both the screen and external door.

The lock systems described above may be used on new door installations, but are also particularly suited for retrofitting. As an illustrative example, the lock system may be retrofitted to a legacy screen door having a Whitco Tasman compatible lock, through replacement of the mortice and the inner and outer lock furniture.

While the lock is illustrated with screen doors, and is particularly suited for use with screen doors, the skilled addressee will readily appreciate that the lock may be used with any pivotally mounted door. As an illustrative example, the lock may be used with a timber door.

While the handles illustrated above are lever handles, the skilled addressee will readily appreciate that any suitable lock furniture may be used, including knob handles.

Advantageously, the door lock systems described above provides a simple and effective manner of utilising digital lock technology on a security screen doors, including together with 3-point locking. Installation is simple as wires need not be connected between inner and outer door portions, and an entirely mechanical mortice may be used that is compact.

As the system provides access control by mechanically coupling and decoupling the handle to the mechanical mortice, the system does not require an electrical actuator for actuating the mechanical mortice, which reduces costs and increases reliability.

In the present specification and claims (if any), the word ‘comprising’ and its derivatives including ‘comprises’ and ‘comprise’ include each of the stated integers but does not exclude the inclusion of one or more further integers.

Reference throughout this specification to ‘one embodiment’ or ‘an embodiment’ means that a particular feature, structure, or characteristic described in connection with the embodiment is included in at least one embodiment of the present invention. Thus, the appearance of the phrases ‘in one embodiment’ or ‘in an embodiment’ in various places throughout this specification are not necessarily all referring to the same embodiment. Furthermore, the particular features, structures, or characteristics may be combined in any suitable manner in one or more combinations.

In compliance with the statute, the invention has been described in language more or less specific to structural or methodical features. It is to be understood that the invention is not limited to specific features shown or described since the means herein described comprises preferred forms of putting the invention into effect. The invention is, therefore, claimed in any of its forms or modifications within the proper scope of the appended claims (if any) appropriately interpreted by those skilled in the art.

1. A door lock system for use on a pivotally mounted door, the door lock system including:
an external digital access control assembly, including a digital access control component and a handle; and
a mechanical mortice, mechanically coupled to the external digital access control assembly;
wherein the digital access control component is configured to selectively provide access control by mechanically coupling and decoupling the handle to the mechanical mortice.

2. The door lock system of claim 1, wherein the door lock system is configured to be installed on a residential door.

3. The door lock system of claim 2, wherein the door lock system is configured to be installed on a screen door.

4. The door lock system of claim 1, wherein the external digital access control assembly is located entirely on an outside of the door.

5. The door lock system of claim 1, wherein the external digital access control assembly includes one or more batteries, for powering the external digital access control assembly, wherein the batteries are housed in a housing of the external digital access control assembly.

6. The door lock system of claim 1, wherein the door lock system includes a clutch, configured to selectively couple the handle to the mechanical mortice.

7. The door lock system of claim 6, wherein the clutch is configured to temporarily couple the handle to the mechanical mortice upon instruction from the digital access control component.

8. The door lock system of claim 6, wherein the clutch is configured to selectively couple the handle to the mechanical mortice using a spindle.

9. The door lock system of claim 6, wherein the clutch is configured to couple the handle to the mortice when the handle is turned in one direction, and not when the handle is turned in the other direction.

10. The door lock system of claim 1, wherein the door lock system includes a keypad, wherein the keypad is configured to receive a code, and provide access control dependent on whether the code is a valid code.

11. The door lock system of claim 10, wherein the keypad is provided on an outer surface of the external digital access control assembly.

12. The door lock system of claim 1, wherein the mortice comprises a centre mortice lock, wherein the system includes an upper and lower lock coupled to the centre mortice lock.

13. The door lock system of claim 12, wherein the centre mortice lock is coupled to the upper and lower locks by one or more actuating bars and/or actuating rods, which are configured to lock/unlock the upper and lower locks through linear movement.

14. The door lock system of claim 12, wherein the mortice comprises an actuating assembly, coupled to the handle, and a linear actuating member, configured to actuate the upper and lower locks, wherein rotation of the actuating assembly causes linear movement of the linear actuating member.

15. The door lock system of claim 1, wherein the lock system includes a lock cylinder, configured to provide keyed access control as an alternative to the external digital access control assembly, wherein the lock cylinder includes a cam, coupled to a barrel thereof, configured to cause translation of a linear actuating member to thereby unlock the door.

16. The door lock system of claim 1, wherein the lock system includes an internal handle that is selectively coupled to a spindle of the lock by one or more buttons.

17. The door lock system of claim 16, wherein the button is located on the handle.

18. The door lock system of claim 16, wherein the button is configured to selectively couple the handle to a spindle of the lock by engaging with a keyed portion of the spindle.

19. An external digital access control assembly for use on a pivotally mounted door, the external digital access control assembly including:
a digital access control component; and
a handle;
wherein the digital access control component is configured to selectively provide access control by mechanically coupling and decoupling the handle to a mortice.

20. An inner door handle assembly for use on a pivotally mounted door, the inner door handle assembly comprising a handle member including a manually activated engagement mechanism, wherein the manually activated engagement mechanism engages with a spindle of the door when the manually activated engagement mechanism is activated, and does not engage with the spindle of the door when the manually activated engagement mechanism is not activated, such that rotation of the handle causes rotation of the spindle when the manually activated engagement mechanism is activated and rotation of the handle is independent of the spindle when the manually activated engagement mechanism is not activated.
